(19) United States
(12) Patent Application Publication
(10) Pub. No.: US 2013/0100582 A1
(43) Pub. Date: Apr. 25, 2013

(54) ELECTRIC DOUBLE LAYER CAPACITOR

(71) Applicants: Chang Ryul Jung, Seoul (KR); Jun Hee Bae, Seoul (KR); Ho Jin Yun, Gyeonggi-do (KR); Bae Kyun Kim, Gyeonggi-do (KR); Yeong Su Cho, Gyeonggi-do (KR)

(72) Inventors: Chang Ryul Jung, Seoul (KR); Jun Hee Bae, Seoul (KR); Ho Jin Yun, Gyeonggi-do (KR); Bae Kyun Kim, Gyeonggi-do (KR); Yeong Su Cho, Gyeonggi-do (KR)

(21) Appl. No.: 13/527,514

(22) Filed: Jun. 19, 2012

(30) Foreign Application Priority Data
Oct. 21, 2011 (KR) 10-2011-0108134

(51) Int. Cl. H01G 9/058; H01G 9/048

(52) U.S. Cl. 361/502

(57) ABSTRACT

The present invention relates to an electric double layer capacitor in which particle sizes of a cathode active material and an anode active material are different from each other, and a difference in the particle size between the cathode active material and the anode active material is 3 to 10 μm; or conductive agent contents in electrode active material compositions of a cathode and an anode are different from each other, and a difference in the conductive agent content between the electrode active material compositions of the cathode and the anode is 5 to 25 wt %.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0108134, entitled filed Oct. 21, 2011, which is hereby incorporated by reference in its entirety into this application.

### BACKGROUND OF THE INVENTION

1. Field of the Invention

The present invention relates to an electric double layer capacitor.

2. Description of the Related Art

A secondary battery and an electric double layer capacitor (EDLC) are mainly used for advanced functions of electronic products and stable power supply to electric vehicles and home and industrial electronic devices.

However, the secondary battery has low power density compared to the EDLC, causes environmental pollution, and has short charge/discharge cycles and risks of overcharging and exploding at high temperature. Therefore, in order to overcome these problems, recently, development of a high performance EDLC with improved energy density is actively in progress.

Recently, as application fields of the EDLC, the market is expanding to systems requiring independent power supply devices, systems of adjusting instantaneous overload, energy storage devices, and so on.

Especially, since the EDLC is highlighted in terms of excellent energy input/output (power density) compared to the secondary battery, the application of the EDLC is expanding to a back-up power supply, that is, an auxiliary power supply which operates in instantaneous power failure.

Further, since the EDLC has excellent charge/discharge efficiency and life compared to the secondary battery, relatively wide available temperature and voltage range, no need for maintenance, and environmentally friendly characteristics, the EDLC is being considered as a substitute for the secondary battery.

Generally, in case of the EDLC, as in the following FIG. 1, it is known that potentials of a cathode and an anode during charge/discharge are the same, and it is reported that a high voltage can be obtained by adjusting the potential of the cathode.

A currently known electrode potential adjusting method of the EDLC increases a voltage of a cell by differentiating weights of the cathode and the anode to make a difference in resistance between the cathode and the anode.

That is, as in the following FIG. 2, in case of using the same electrode active material, there is a method of adjusting thicknesses of a cathode active material 12 and an anode active material 22 in an electrode consisting of a cathode 10 including the cathode active material 12 on a cathode current collector 11 and an anode 20 including the anode active material 22 on an anode current collector 11.

Otherwise, the electrode potential may be adjusted by adjusting weights of the active materials applied on the cathode and the anode.

However, since it is impossible to effectively adjust a potential difference between the cathode and the anode by the currently used methods, there is a limit to improvement of the voltage of the EDLC cell.

### SUMMARY OF THE INVENTION

The present invention has been invented in order to overcome the above-described problems in manufacturing a high voltage electric double layer capacitor and it is, therefore, an object of the present invention to provide an electric double layer capacitor capable of improving energy density and a withstand voltage of a cell by adjusting a potential difference between a cathode and an anode.

In accordance with an embodiment of the present invention to achieve the object, there is provided an electric double layer capacitor characterized in that particle sizes of a cathode active material and an anode active material are different from each other, and a difference in the particle size between the cathode active material and the anode active material is 3 to 10 μm.

It is preferred that the cathode active material and the anode active material have a D50 in the range of 3 to 20 μm.

The cathode active material and the anode active material may be equal to or different from each other, and each of them may be preferably at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

It is preferred that the cathode active material and the anode active material are activated carbon with a specific surface area of 1.500 to 3.000 m²/g.

In accordance with another embodiment of the present invention to achieve the object, there is provided an electric double layer capacitor characterized in that conductive agent contents in electrode active material compositions of a cathode and an anode are different from each other, and a difference in the conductive agent content between the electrode active material compositions of the cathode and the anode is 5 to 25wt %.

It is preferred that the conductive agent content in the electrode active material composition of the anode is relatively higher than that in the electrode active material composition of the cathode.

It is preferred that the conductive agent in accordance with the present invention is at least one conductive powder selected from the group consisting of super-P, Ketjen black, acetylene black, carbon black, and graphite.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a graph of a potential value according to charge/discharge of a conventional electric double layer capacitor;

FIG. 2 is an example of a method of adjusting a potential of an electrode using a conventional method; and

FIG. 3 shows an electrode structure in accordance with an embodiment of the present invention.

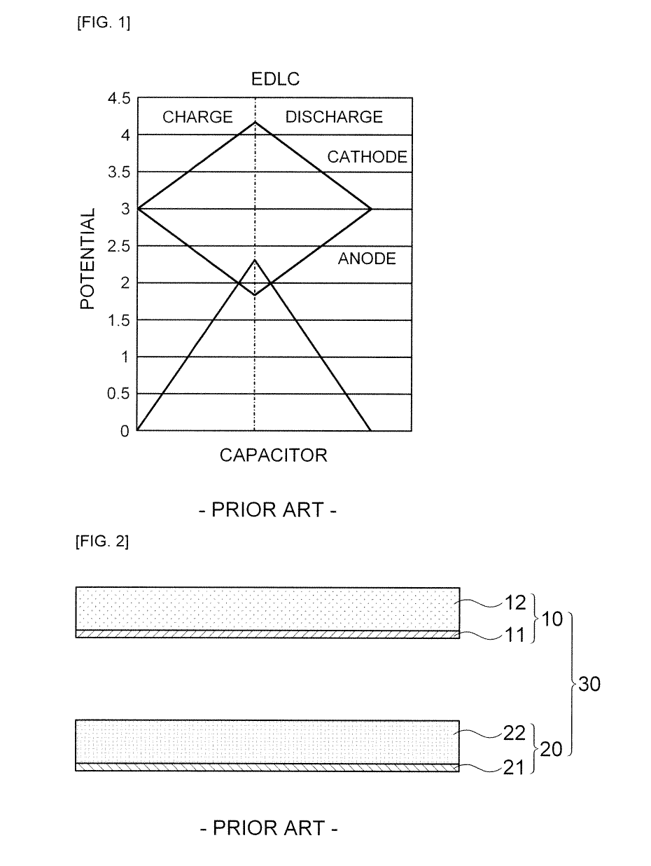

### DETAILED DESCRIPTION OF THE PREFERABLE EMBODIMENTS

Hereinafter, the present invention will be described in detail.

Terms used herein are provided to explain embodiments, not limiting the present invention. Throughout this specification, the singular form includes the plural form unless the context clearly indicates otherwise. Further, terms “comprises” and/or “comprising” used herein specify the existence of described shapes, numbers, steps, operations, members, elements, and/or groups thereof, but do not preclude the existence or addition of one or more other shapes, numbers, operations, members, elements, and/or groups thereof.

The present invention relates to an electric double layer capacitor in which electrode active materials of different particle sizes are used in a cathode and an anode or conductive agent contents in the cathode and the anode are different from each other.

More specifically, an electric double layer capacitor in accordance with a first embodiment of the present invention is characterized in that particle sizes of a cathode active material and an anode active material are different from each other and a difference in the particle size between the cathode active material and the anode active material is 3 to 10 μm.

It is preferred that the cathode active material and the anode material have a D50 in the range of 3 to 20 μm.

That is, a potential difference of a cell is adjusted by differentiating size distribution of materials used as the electrode active materials of the cathode and the anode to make a difference in electrode density of the cathode and the anode. In this case, it is preferred to maintain resistance of the anode low by reducing the electrode density of the cathode and increasing the energy density of the anode.

It is preferred that the present invention is designed to have a difference in the particle size between the cathode active material and the anode active material of 3 to 10 μm. When the difference in the particle size between the cathode active material and the anode active material is less than 3 μm, it is not preferred since a difference in size distribution is slight and thus it is impossible to increase a withstand voltage of the cell due to a difference in resistance. When the difference in the particle size between the cathode active material and the anode active material exceeds 10 μm, it is not preferred since capacity of the cell is reduced.

The cathode active material and the anode active material in accordance with the present invention may be equal to or different from each other, and each of them may be preferably at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene but not limited thereto.

Among them, it is preferred that the anode active material and the cathode active material may be activated carbon with a specific surface area of 1,500 to 3,000 m²/g.

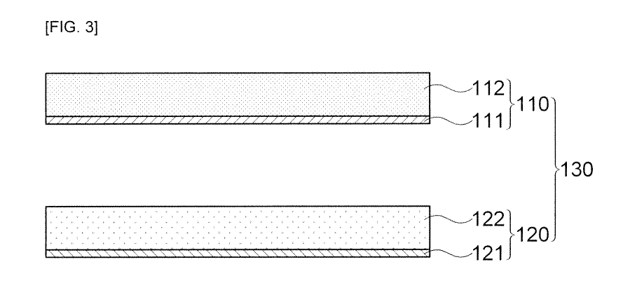

The following FIG. 3 shows an example of an electrode 130 in accordance with an embodiment of the present invention. Referring to this, the electrode 130 includes a cathode 110, which includes a cathode active material 112 on a cathode current collector 111, and an anode 120, which is formed by applying an anode active material 122 on an anode current collector 121. At this time, materials with wide size distribution are used as the cathode active material 112 to increase the electrode density. Further, materials with relatively narrower size distribution than the cathode active material 112 are used as the anode active material 122 to reduce the electrode density so that resistance of the anode is reduced.

An electric double layer capacitor in accordance with a second embodiment of the present invention increases a withstand voltage of a cell by differentiating conductive agent contents in electrode active material compositions of a cathode and an anode to use a difference in resistance between the cathode and the anode.

At this time, resistance of the anode is reduced by relatively increasing the conductive agent content in the anode than the conductive agent content in the cathode, that is, by making a difference in the conductive agent content between the electrode active material compositions of the cathode and the anode 5 to 25 wt %.

When the difference in the conductive agent content between the electrode active material compositions of the cathode and the anode is less than 5 wt %, it is not preferred since it is impossible to increase the withstand voltage of the cell due to the small difference in the resistance between the cathode and the anode. Further, when the difference in the conductive agent content exceeds 25 wt %, it is not preferred since capacity of the cell is reduced.

It is preferred that the conductive agent in accordance with the present invention is at least one conductive powder selected from the group consisting of super-P, ketjen black, acetylene black, carbon black, and graphite.

In the electric double layer capacitor in accordance with the present invention, the cathode, which is formed by applying cathode active material slurry including a cathode active material, the conductive agent, and a binder on a cathode current collector, and the anode, which is formed by forming a conductive layer on an anode current collector and applying anode active material slurry including an anode active material, the conductive agent, and a binder on the conductive layer, are immersed in an electrolytic solution while being insulated by a separator.

Further, a mixture of the electrode active material, the conductive agent, and a solvent is formed into a sheet by the binder resin or a sheet extruded by extrusion is bonded to the current collector by a conductive adhesive.

The cathode current collector in accordance with the present invention may be made of materials used in conventional electric double layer capacitors and lithium ion batteries, for example, at least one selected from the group consisting of aluminum, stainless steel, titanium, tantalum, and niobium. Among them, aluminum is preferable.

It is preferred that a thickness of the cathode current collector is 10 to 40 μm. In addition to the above metal foils, etched metal foils or materials such as expanded metal, punched metal, nets, and foam having holes penetrating front and rear surfaces can be used as the current collector.

Further, the anode current collector in accordance with the present invention may be made of all materials used in the conventional electric double layer capacitors and lithium ion batteries, for example, aluminum, stainless steel, copper, nickel, and alloys thereof. Among them, aluminum is preferable. Further, it is preferred that a thickness of the anode current collector is 10 to 40 μm. In addition to the above metal foils, etched metal foils or materials such as expanded metal, punched metal, nets, and foam having holes penetrating front and rear surfaces can be used as the current collector.

The respective electrode active materials and the conductive agent are as described above.

For example, the binder resin may be at least one selected from fluorine resins such as polytetrafluoroethylene (PTFE) and polyvinylidenfluoride (PVDF); thermoplastic resins such as polyimide, polyamideimide, polyethylene (PE), and polypropylene (PP); cellulose resins such as carboxymethyl cellulose (CMC); rubber resins such as styrene-butadiene rubber (SBR); and mixtures thereof but not particularly limited thereto. All binder resins used in typical electrochemical capacitors can be used.

The separator in accordance with the present invention may use all materials used in the conventional electric double layer capacitors or lithium ion batteries, for example, a microporous film manufactured from at least one polymer selected from the group consisting of polyethylene (PE), polypropylene (PP), polyvinylidenfluoride (PVDF), polyvinylidene chloride, polyacrynitrile (PAN), polyacrylamide (PAAm), polytetrafluoroethylene (PTFE), polysulfone, polyether sulfone (PES), polycarbonate (PC), polyamide (PA), polyimide (PI), polyethyleneoxide (PEO), polypropylene oxide (PPO), cellulose polymers, and polyacrylic polymers. Further, a multilayer film manufactured by polymerizing the porous film may be used, and among them, cellulose polymers may be preferably used.

It is preferred that a thickness of the separator is about 15 to 35 μm but not limited thereto.

The electrolytic solution of the present invention may be organic electrolytic solutions containing non-lithium salts such as spiro salts, TEABF₄, and TEMABF₄ or lithium salts such as LiPF₆, LiBF₄, LiCLO₄, LiN(CF₃SO₂)₂, CF₃SO₃Li, LiC(SO₂CF₃)₃, LiAsF₆, and LiSbF₆ or mixtures thereof. The solvent may be at least one selected from the group consisting of acrylonitrile, ethylene carbonate, propylene carbonate, dimethyl carbonate, ethyl methyl carbonate, sulfolane, and dimethoxyethane but not limited thereto. The electrolytic solution, in which these solute and solvent are mixed, has a high withstand voltage and high electrical conductivity. It is preferred that concentration of an electrolyte in the electrolytic solution is in the range of 0.1 to 2.5 mol/L, particularly 0.5 to 2.0 mol/L.

It is preferred that a case (exterior material) of the electrochemical capacitor of the present invention uses an aluminum-containing laminate film, which is typically used in secondary batteries and electric double layer capacitors, but not particularly limited thereto.

Hereinafter, preferred embodiments of the present invention will be described in detail. The following embodiments merely illustrate the present invention, and it should not be interpreted that the scope of the present invention is limited to the following embodiments. Further, although certain compounds are used in the following embodiments, it is apparent to those skilled in the art that equal or similar effects are shown even when using their equivalents.

### EMBODIMENT 1

### 1) Preparation of Anode

Anode active material slurry is prepared by mixing and stirring vapor activated carbon (D50=6 μm, specific surface area 1800 m²/g) 123 g, super-P 15 g as a conductive agent, carboxymethyl cellulose (CMC) 3.8 g, styrene-butadiene rubber (SBR) 5.3 g, and polytetrafluoroethylene (PTFE) 2.2 g as binders, and water 473 g.

The anode active material slurry is applied on an aluminum current collector with a thickness of 20 μm by a comma coater, temporarily dried, and cut to an electrode size of 50 mm×100 mm. A cross-sectional thickness of the electrode is 60 μm. Before assembly of a cell, the electrode is dried in a vacuum at 120° C. for 48 hours.

### 2) Preparation of Cathode

Cathode active material slurry is prepared by mixing and stirring alkali activated carbon (D50=10 μm, specific surface area 2200 m²/g) 123 g, super-P 15 g as a conductive agent, carboxymethyl cellulose (CMC) 3.8 g, styrene-butadiene rubber (SBR) 5.3 g, and polytetrafluoroethylene (PTFE) 2.2 g as binders, and water 473 g.

The cathode active material slurry is applied on an etched aluminum foil with a thickness of 20 μm by a comma coater, temporarily dried, and cut to an electrode size of 50 mm×100 mm. A cross-sectional thickness of the electrode is 60 μm. Before assembly of the cell, the electrode is dried in a vacuum at 120° C. for 48 hours.

### 3) Preparation of Electrolytic Solution

An electrolytic solution is prepared by dissolving a spiro salt in an acrylonitrile solvent so that concentration of the Spiro salt is 1.3 mol/L.

### 4) Assembly of Electric Double Layer Capacitor Cell

The prepared electrodes (cathode, anode) are immersed in the electrolytic solution with a separator (TF4035 from NKK, cellulose separator) interposed therebetween and put in a laminate film case to be sealed.

### EMBODIMENT 2

### 1) Preparation of Anode

Anode active material slurry is prepared by mixing and stirring vapor activated carbon (specific surface area 1800 m²/g) 123g, super-P 15 g as a conductive agent, carboxymethyl cellulose (CMC) 3.8 g, styrene-butadiene rubber (SBR) 5.3 g, and polytetrafluoroethylene (PTFE) 2.2 g as binders, and water 473 g.

The anode active material slurry is applied on an aluminum current collector with a thickness of 20 μm by a comma coater, temporarily dried, and cut to an electrode size of 50 mm×100 mm. A cross-sectional thickness of the electrode is 60 μm. Before assembly of a cell, the electrode is dried in a vacuum at 120° C. for 48 hours.

### 2) Preparation of Cathode

Cathode active material slurry is prepared by mixing and stirring vapor activated carbon (specific surface area 1800 m²/g) 131 g, super-P 7.5 g as a conductive agent, carboxymethyl cellulose (CMC) 3.8 g, styrene-butadiene rubber (SBR) 5.3 g, and polytetrafluoroethylene (PTFE) 2.2 g as binders, and water 473 g.

The cathode active material slurry is applied on an etched aluminum foil with a thickness of 20 μm by a comma coater, temporarily dried, and cut to an electrode size of 50 mm×100 mm. A cross-sectional thickness of the electrode is 60 μm. Before assembly of the cell, the electrode is dried in a vacuum at 120° C. for 48 hours.

### 3) Preparation of Electrolytic Solution

An electrolytic solution is prepared by dissolving a Spiro salt in an acrylonitrile solvent so that concentration of the spiro salt is 1.3 mol/L.

### 4) Assembly of Electric Double Layer Capacitor Cell

The prepared electrodes (cathode, anode) are immersed in the electrolytic solution with a separator (TF4035 from NKK, cellulose separator) interposed therebetween and put in a laminate film case to be sealed.

### COMPARATIVE EXAMPLE 1

An electric double layer capacitor is manufactured by the same process as the embodiment 1 except for applying active material slurry, which is prepared by mixing and stirring vapor activated carbon (specific surface area 1800 m²/g) 123 g, super-P 15 g as a conductive agent, carboxymethyl cellulose (CMC) 3.8 g, styrene-butadiene rubber (SBR) 5.3 g, and polytetrafluoroethylene (PTFE) 2.2 g as binders, and water 473 g, on cathode and anode current collectors.

### Experimental Example; Estimation of Capacity and Resistance of Electrochemical Capacitor Cell

Capacity of the last cycle is measured by charging electric double layer capacitor cells manufactured according to the embodiments 1 and 2 and the comparative example 1 to 2.5V at constant current and constant voltage with a current density of 1 mA/cm² and discharging the cells at constant current of 1 mA/cm² three times after 30 minutes under the condition of a constant temperature of 25 ° C., and measurement results are shown in the following table 1.

Further, resistance of each cell is measured by an ampere-ohm meter and an impedance spectroscopy, and measurement results are shown in the following table 1.

TABLE 1

| | Initial | Resistance |
|---|---|---|
| Classification | Capacity (F) | (AC ESR, m Ω) |
| Comparative Example 1 | 1062 | 0.394 |
| Embodiment 1 | 1042 | 0.359 |
| Embodiment 2 | 1098 | 0.437 |

As in the results of the table 1, it is possible to reduce resistance by about 10% compared to the electrodes according to the comparative example 1 including the same amount of the active material and the conductive agent by making a difference in size distribution of the electrode active materials included in the cathode and the anode. Further, it is possible to increase resistance by differentiating the conductive agent contents. By using this, it is possible to improve a withstand voltage by making a difference in resistance of the cathode and the anode to adjust a potential difference of the cell, thereby improving energy density of the cell.

According to the present invention, the potential difference of the electric double layer capacitor cell is adjusted through the resistance difference between the cathode and the anode by using the electrode active materials of different particle sizes in the cathode and the anode or including different amounts of the conductive agent in the cathode and the anode. Therefore, it is possible to minimize capacity reduction compared to conventional methods and improve the energy density of the cell by improving the withstand voltage of the cell.

What is claimed is:

1. An electric double layer capacitor characterized in that particle sizes of a cathode active material and an anode active material are different from each other, and a difference in the particle size between the cathode active material and the anode active material is 3 to 10 μm.

2. The electric double layer capacitor according to claim 1, wherein the cathode active material and the anode active material have a D50 in the range of 3 to 20 μm, respectively.

3. The electric double layer capacitor according to claim 1, wherein the cathode active material and the anode active material are equal to or different from each other, and each of the cathode active material and the anode active material is at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor grown carbon fiber (VGCF), and graphene.

4. The electric double layer capacitor according to claim 1, wherein the cathode active material and the anode active material are activated carbon with a specific surface area of 1.500 to 3.000 m²/g.

5. An electric double layer capacitor characterized in that conductive agent contents in electrode active material compositions of a cathode and an anode are different from each other, and a difference in the conductive agent content between the electrode active material compositions of the cathode and the anode is 5 to 25 wt %.

6. The electric double layer capacitor according to claim 5, wherein the conductive agent content in the electrode active material composition of the anode is relatively higher than that in the electrode active material composition of the cathode.

7. The electric double layer capacitor according to claim 5, wherein the conductive agent is at least one conductive powder selected from the group consisting of super-P, Ketjen black, acetylene black, carbon black, and graphite.

8. The electric double layer capacitor according to claim 5, wherein the cathode active material and the anode active material are equal to or different from each other, and each of the cathode active material and the anode active material is at least one carbon material selected from the group consisting of activated carbon, carbon nanotube (CNT), graphite, carbon aerogel, polyacrylonitrile (PAN), carbon nanofiber (CNF), activated carbon nanofiber (ACNE), vapor grown carbon fiber (VGCF), and graphene.

9. The electric double layer capacitor according to claim 5, wherein the cathode active material and the anode active material are activated carbon with a specific surface area of 1.500 to 3.000 m /g.
